(19) United States
(12) Patent Application Publication
(10) Pub. No.: US 2021/0283505 A1
(43) Pub. Date: Sep. 16, 2021

(54) Video Game Content Provision System and Method

(71) Applicant: Electronic Arts Inc., Redwood City, CA (US)

(72) Inventors: Tushar Bansal, San Francisco, CA (US); Fernando De Mesentier Silva, San Francisco, CA (US); Reza Pourabolghasem, San Mateo, CA (US); Sundeep Narravula, Saratoga, CA (US); Navid Aghdaie, San Jose, CA (US); Kazi Zaman, Foster City, CA (US)

(21) Appl. No.: 16/814,242

(22) Filed: Mar. 10, 2020

(51) Int. Cl. A63F 13/60; G06N 20/00; G06N 3/04; G06F 11/34; A63F 13/25

(52) U.S. Cl. CPC A63F 13/60; G06N 20/00; A63F 13/25; G06F 11/3466; G06N 3/0454

(57) ABSTRACT

A computer-implemented method for providing video game content is provided. The method comprises maintaining a current machine learning model for each of a plurality of machine learning model branches; receiving a request to provide video game content responsive to specified input; in response to receiving the request, identifying a selected one of the machine learning model branches, wherein the machine learning model branch is selected based on an evaluation of the current machine learning model for each branch; and providing video game content responsive to the request, wherein providing the video game content comprises generating an output responsive to the specified input with the current machine learning model for the selected branch.

### BACKGROUND

Machine learning techniques and models have found application in a variety of technical fields. In recent times, there has been increasing interest in the use of machine learning in the field of video games.

### SUMMARY

In accordance with a first aspect, the specification describes a computer-implemented method for providing video game content using a dynamically selected machine learning model. The method comprises: maintaining a current machine learning model for each of a plurality of machine learning model branches; receiving a request to provide video game content responsive to specified input; in response to receiving the request, identifying a selected one of the machine learning model branches; and providing video game content responsive to the request. The current machine learning model for each branch is successively updated, where each update comprises adjusting parameters of the model to optimise an objective function based on a set of training data for the update. The machine learning model branch is selected based on an evaluation of the current machine learning model for each branch. The evaluation comprises generating one or more test outputs using the current machine learning model for each branch; and determining, based on the one or more test outputs, a value of a performance metric for the current machine learning model for each branch. The provision of the video game content comprises generating an output responsive to the specified input with the current machine learning model for the selected branch.

In accordance with a second aspect, the specification describes a distributed computing system for providing video game content using a dynamically selected machine learning model. The distributed computer system is configured to maintain a current machine learning model for each of a plurality of machine learning model branches; receive a request to provide video game content responsive to specified input; in response to receiving the request, identify a selected one of the machine learning model branches; and provide video game content responsive to the request. The current machine learning model for each branch is successively updated, where each update comprises adjusting parameters of the model to optimise an objective function based on a set of training data for the update. The machine learning model branch is selected based on an evaluation of the current machine learning model for each branch. The provision of the video game content comprises generating an output responsive to the specified input with the current machine learning model for the selected branch.

In accordance with a third aspect, the specification describes one or more non-transitory computer readable media storing computer program code. When executed by one or more processing devices, the computer program code causes the one or more processing devices to perform operations comprising: maintaining a current machine learning model for each of a plurality of machine learning model branches; receiving a request to provide video game content responsive to specified input; in response to receiving the request, identifying a selected one of the machine learning model branches; and providing video game content responsive to the request. The current machine learning model for each branch is successively updated, where each update comprises adjusting parameters of the model to optimise an objective function based on a set of training data for the update. The machine learning model branch is selected based on an evaluation of the current machine learning model for each branch. The evaluation comprises generating one or more test outputs using the current machine learning model for each branch; and determining, based on the one or more test outputs, a value of a performance metric for the current machine learning model for each branch. The provision of the video game content comprises generating an output responsive to the specified input with the current machine learning model for the selected branch.

### BRIEF DESCRIPTION OF THE DRAWINGS

Certain embodiments of the present invention will now be described, by way of example, with reference to the following figures.

FIG. 1 is a schematic block diagram illustrating an example of a computer system configured to provide video game content using a dynamically selected machine learning model;

FIG. 2 is a schematic block diagram illustrating the development and selection of machine learning model branches in a computer system configured to provide video game content;

FIG. 3 is a flow diagram of an example method for providing video game content; and

FIG. 4 is a flow diagram of an example method for selecting a machine learning model branch.

### DETAILED DESCRIPTION

Example implementations provide systems and methods for improved provision of video game content using a machine learning model. For example, systems and methods described herein may improve the quality of provided video game content as measured using one or more of objective content quality measures, assessments from video game content creators, and feedback from video game players. Examples of video game content that may be provided include, but are not limited to, speech, music, non-player character behaviour, character animations, player character choice recommendations, game mode recommendations, video game terrain and the location of entities, e.g. objects, characters and resources, within a video game environment.

In accordance with various example implementations, methods and systems for providing video game content using a dynamically selected machine learning model are described. The dynamically selected machine learning model is a current machine learning model of a selected machine learning model branch of a machine learning model ‘forest’. The current machine learning model for each of the branches of the machine learning model ‘forest’ has been derived by successively updating prior model(s) on that branch, e.g. by incrementally training a machine learning model on that branch. The properties of the machine learning models on each branch may be different. For example, the machine learning models on each branch may be initialized differently, trained differently, be of different types and/or have different properties.

As the machine learning models on each branch are successively updated, the current machine learning model for each of the machine learning model branches is evaluated. Based on the evaluations, one of the machine learning model branches is selected. For example, each evaluation may determine a value of a performance metric for the current machine learning model on that branch, and the branch for which the value of the performance metric for the current machine learning model is greatest may be selected. The current machine learning model on the selected branch can then be used to provide video game content, e.g. the machine learning model may be used to generate outputs which are themselves video game content or from which video game content is derivable.

The machine learning model variation usable to provide the highest quality video game content may change throughout training. Using the described systems and methods, higher quality video game content is consistently provided using the most favourably evaluated of the current machine learning models, while continuing to train the machine learning models on the other branches which, with more training, may be usable to provide higher quality video game content.

### Video Game Content Provision System

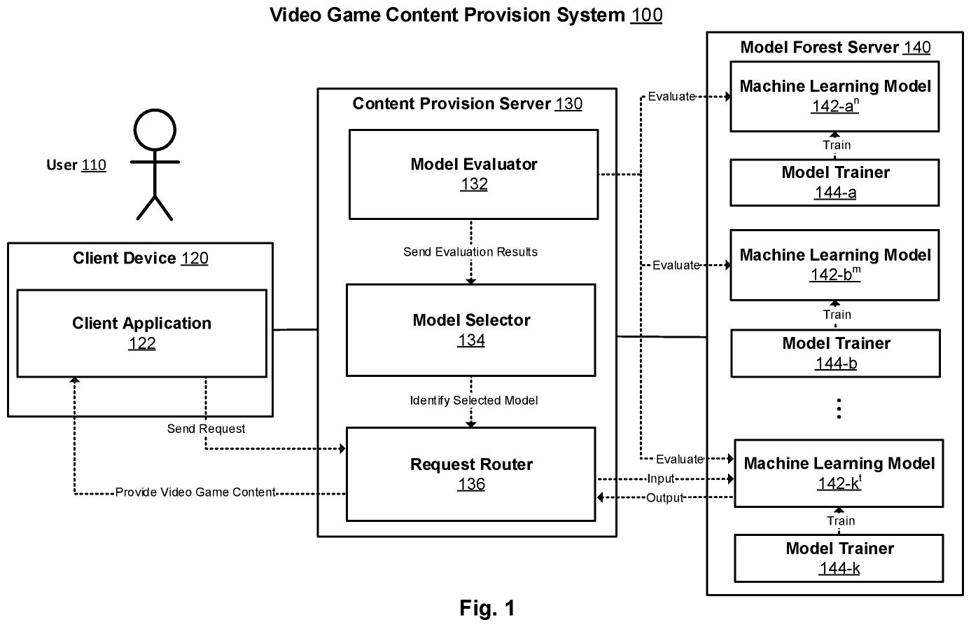

Referring to FIG. 1, a video game content provision system for providing video game content using a dynamically selected machine learning model is shown.

The video game content provision system 100 includes a client computing device 120 operable by a user 110, content provision server 130, and a model forest server 140. The client computing device 120 is configured to communicate with the content provision server 130 over a network. Similarly, the content provision server 130 is configured to communicate with the model forest server 140 over the same or another network. Examples of suitable networks include the internet, intranets, virtual private networks, local area networks, wireless networks and cellular networks. For the sake of clarity, the video game content provision system 100 is illustrated as comprising a specific number of devices. Any of the functionality described as being performed by a specific device may instead be performed across a number of computing devices, and/or functionality described as being performed by multiple devices may be performed on a single device. For example, multiple instances of the content provision server 130 and/or the model forest server 140 may be hosted as virtual machines or containers on one or more computing devices of a public or private cloud computing environment.

The client computing device 120 can be any computing device suitable for providing the client application 120 to the user 110. For example, the client computing device 120 may be any of a laptop computer, a desktop computer, a tablet computer, a video games console, or a smartphone. For displaying the graphical user interfaces of computer programs to the user 110, the client computing device includes or is connected to a display (not shown). Input device(s) (not shown) are also included or connected to the client. Examples of suitable input devices include keyboards, touchscreens, mice, video game controllers, microphones and cameras.

The client computing device 120 provides a client application 122 to the user 110. The client application 122 is any computer program capable of requesting and receiving video game content from the content provision server 130.

The client application 122 may be game creation software, e.g. game or franchise specific content creation tools, a game engine integrated development environment, or a general purpose integrated development environment usable with one or more game development specific extensions. To indicate that video game content is desired, the user no may provide a content request input to the game creation software, e.g. a keyboard shortcut or selection of a user interface element, to indicate that video game content is to be requested. The input may relate to a desired type of video game content, e.g. speech audio, music, non-player character behaviour, character animations, video game terrain, and locations for entities in a video game environment. In response to the content request input, a dialog window or pane for specifying properties for deriving the desired video game content may be displayed. For example, when speech audio is desired, the dialog window or pane may include user interface elements for indicating the content to be spoken, e.g. for inputting text or selecting a text file; an emotional tone of the speech, e.g. whether the speech audio should sound happy, sad, angry, or inquisitive; and/or properties of a video game character from which the speech audio is to originate. A content request confirmation input, e.g. a keyboard button press or a user interface element selection, may then be provided by the user to confirm that they desire video game derived using the specified properties. Properties for deriving the desired video game content may alternatively or additionally be specified in one or more configuration files. For example, details of the character, e.g. age, gender, and dialect, from which speech audio is to be derived may be stored in one or more configuration files associated with that character. In response to the content request input and/or the content request confirmation input, the game creation software sends a request to provide video game content to the content provision server 130. The request to provide video game content includes the specified properties for deriving the video game content, or a representation of the specified properties, e.g. an XML or JSON representation of the specified properties. In response to the request, the content provision server 130 provides video game content of the desired type to the game creation software, which the user 110, e.g. a video game designer or developer, may include in the video game being developed.

The client application 122 may be content creation software, e.g. a 3D computer graphics software, software for texture map creation and editing, or audio editing software. The functionality for requesting video game content may be implemented as a plug-in and/or extension for the content creation software. The type of content requested may depend on the type of content creation software. For example, music and/or speech audio may be requested using audio editing software; texture maps may be requested using software for texture map creation and editing; and game environment terrain meshes, character models and/or character animations may be requested using a 3D computer graphics application. To indicate that video game content is desired, the user 110 may provide a content request input to the content creation software, e.g. a keyboard shortcut or selection of a user interface element. In response to the content request input, a dialog window or pane for specifying properties for deriving the desired video game content may be displayed. For example, when game environment terrain is desired, the dialog window or pane may include user interface elements for indicating terrain properties, e.g. fractal noise values, geological properties, and degree of erosion. A content request confirmation input, e.g. a keyboard button press or a user interface element selection, may then be provided by the user to confirm that they desire video game derived using the specified properties. Properties for deriving the desired video game content may alternatively or additionally be specified in one or more configuration files, e.g. locations of waterways to be included in a terrain mesh. In response to the content request input and/or the content request confirmation input, the game creation software sends a request to provide video game content to the content provision server 130. The request to provide video game content includes the specified properties for deriving the video game content, or a representation of the specified properties, e.g. an XML or JSON representation of the specified properties. In response to the request, the content provision server 130 provides video game content of the desired type to the content creation software, which the user 110, e.g. a content creator, may refine and/or build upon to produce polished video game content.

The client application 122 may be a video game. The video game may dynamically request video game content from the content provision server 130 while the user 110, e.g. a video game player, is playing the video game. For example, as the user 110 plays the video game, music may be requested from the content provision server 130. Properties of the current video game state, e.g. properties of the video game environment and the player character, may be included in the request to be used for deriving the video game content. For example, it may be desirable that the music depends on the player character's health and the number of enemies in their immediate vicinity, so these properties, or properties derived therefrom, may be included in the request. The video game may additionally or alternatively request video game content in response to a content request input by a player. For example, a video game may include an apparel designer which players can use to design apparel for their in-game avatars. In the apparel designer, the player may select various desired properties of the apparel, e.g. the type of apparel, one or more colours and a style, then, based on these selections, a request including the desired properties for in-game apparel is made, by the video game, to the content provision server 130. In response to the request, the content provision server provides video game content, e.g. a 3D mesh and a texture map, representing apparel with the desired properties, to the video game, and the video game may use the provided video game content to display the in-game avatar wearing the apparel with the desired properties.

Each server 130, 140 includes one or more processors (not shown), a memory (not shown) and a network interface (not shown). The processor(s) of each server execute suitable instructions stored in a computer-readable medium, e.g. memory. The network interface of each server is used to communicate with the other components of the system 100 to which the server is connected.

The content provision server provides a model evaluator 132, a model selector 134, and a request router 136.

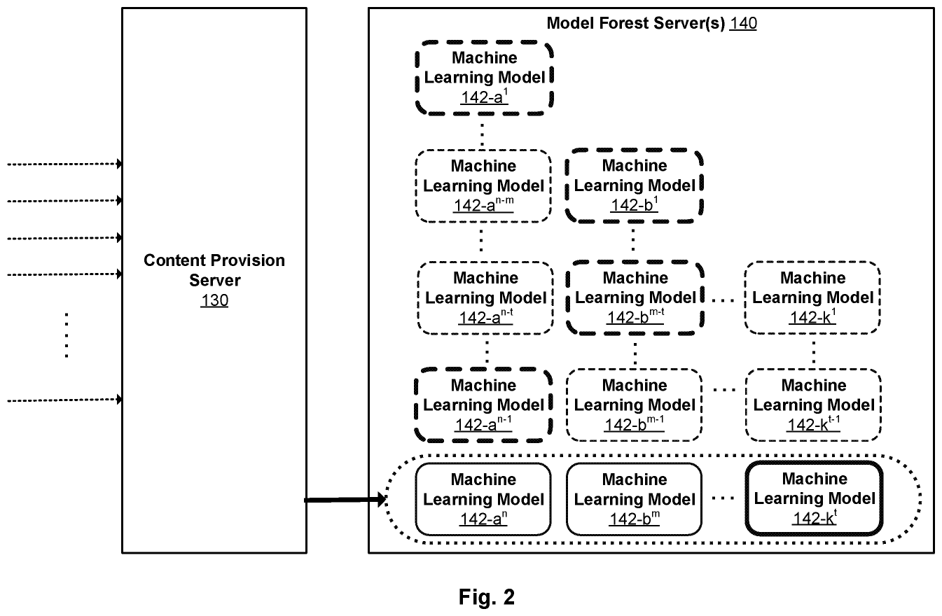

The model evaluator 132 evaluates a plurality of machine learning models 142 hosted on the model forest server 140. Each of the plurality of machine learning models 142 may be a current machine learning model of a machine learning model branch of a machine learning model forest, as will be explained in more detail relation to FIG. 2. The model evaluator 132 evaluates each of the plurality of machine learning models.

The model evaluator 132 evaluates each machine learning model by generating one or more test outputs using the machine learning model and determining a performance metric based on these test outputs. The performance metric value may directly or indirectly measure the quality of the video game content which can be provided using these outputs. These test outputs may be video game content or outputs from which video game content may be derived, e.g. phonemes and/or spectrogram frames for speech audio, a terrain heightfield for use in generating a 3D mesh for an in-game terrain, or latent embeddings of the video game content. There may be a pair of a test input and a ground-truth output, of the same type as the test output, associated with each of the test outputs, which may be used in determining the performance metric. These pairs of a test input and a ground-truth output may be referred to as test pairs and may be collectively referred to as the test set. The test set may be used to evaluate the machine-learning model by inputting each of the test inputs to the machine learning model, generating the respective test output, and calculating a measure of the difference between the respective test output and the ground-truth output. The measure may be a loss function, or a component thereof, used for training at least one of the plurality of machine learning models. However, it may also be a non-loss function measure, e.g. a non-differentiable measure. The performance metric may be a summary of these values across the test set, and the performance metric may be non-differentiable. For example, the performance metric may be a sum or average of the measures for each test pair.

The model selector 134 receives the results of the evaluation for each of the plurality of machine learning models from the model evaluator 132 and selects a machine learning model based on the results of the evaluation. For example, the selected machine learning model may be the machine learning model for which the performance metric value is highest. However, other factors, in addition to the performance metric values, may be taken into account when making. For example, the selection may be based on both the performance metric value and the latency, e.g. the time it takes the machine learning model to generate an output, for each model. This selection could be made by deriving a combined metric for each machine learning model including components for the performance metric value and the latency, and selecting the machine learning model having the highest value for the combined metric. An example of such a combined metric is a weighted sum of the performance metric value and the latency, e.g. αp+βl, where p is the performance metric value, l is the latency, and α and β are weights.

Subsequent to selecting the machine learning model, the model selector 134 identifies the selected machine learning model 142-k^{t} to the request router 136. The model selector 134 may identify the selected machine learning model to the request router using any suitable mechanism. Examples of suitable mechanisms for identifying the selected machine learning model to the request model may include communicating the selected machine learning model by an application programming interface call; a service call, e.g. a representational state transfer (REST) call or a Simple Object Access Protocol (SOAP) call; a message queue; or memory shared between the model selector 134 and the request router 136.

The request router 136 receives requests, from the client application 122, to provide video game content responsive to specified input. The request may be received by the request router from the client application using any suitable mechanism, e.g. a REST call or a SOAP call; or a message queue.

The request may identify the type of video game content to be provided, e.g. where the content provision server 130 is usable to provide multiple types of video game content. The type of video game content identified could be, but is not limited to, the types of video game content described above, e.g. speech audio, music, non-player character behaviour, character animations, video game terrain, locations for entities in a video game environment.

The specified input may be included in the request, and/or the specified input, or a part thereof, may have been sent, by the client device 120, to the content provision server 130 in an earlier operation or may be retrieved, e.g. from a game environment server, by the request router 136 or a content retrieval module (not shown). The specified input may include properties usable for providing the type of desired video game content. For example, the specified input may include desired traits of the video game content, e.g. for speech audio, whether the speech audio should sound happy, sad, angry, or inquisitive; and/or properties of a video game character from which the speech audio is to originate. Alternatively or additionally, the specified input may include other data which the provided video game content is to depend on. For example, where the client application 120 is a video game, it may be desired that the video game content, e.g. music, depends on the current game state, e.g. the health of an in-game character, the location of the in-game character, and the number of enemies in the in-game character's immediate vicinity.

In response to the received request, the request router 136 requests an output from the selected machine learning model 142-k^{t}. If the request received by the request router 136 can be inputted to the selected machine learning model 142-k^{t} then the request router 136 may forward the received request to the selected machine learning model 142-k^{t}. Otherwise, the request router 136 processes the received request in order to derive one or more inputs based on the request that can be processed by the selected machine learning model 142-k^{t}, and communicates these inputs to the selected machine learning model 142-k^{t}. These one or more inputs can then be communicated to the machine learning model 142-k^{t}. For example, when speech audio is requested, the type of input processable by the selected machine learning model 142-k^{t} may be a series of character embeddings, and the text in the request may be converted into suitable character embeddings by the request router 136. The type of input processable by each of the machine learning models 142 may be the same, or the type of input processable by different machine learning models 142 may vary. Where the types of input processable by different machine learning models 142 varies, the request router 136 may derive appropriate inputs based on the received request for the selected one of the machine learning models. For example, one machine learning model for generating speech audio may use character embeddings as input and another one of the machine learning model mays use word embeddings as input.

In response to the inputting, by the request router 136, to the selected machine learning model 142-k^{t}, the request router 136 receives output from the selected machine learning model 142-k^{t} which is video game content or from which video game content can be derived. Where the request router 136 receives output from which video game content can be derived, the request router 136 processes the output to derive video game content. For example, in the case of speech audio, the machine learning model may return a series of spectrograms transformable into audio snippets. The request router 136 may transform the spectrograms into audio snippets, e.g. by transforming them from the frequency domain to the time domain, concatenate the audio snippets, and encode the resulting audio data in an appropriate file format. As another example, in the case of terrain generation, the machine learning model may output a terrain heightfield. The request router 136 may transform the terrain heightfield into a 3D mesh for the terrain. The video game content is then provided to the client application 120 by the request router 136.

The model forest server 140 provides a plurality of machine learning models 142 and a corresponding plurality of machine learning model trainers 144.

Each of the plurality of machine learning models 142 is a current machine learning model of a machine learning model branch of a machine learning model forest. As described above, each of the plurality of machine learning models 142 is configured to receive input from the request router 136 and generate output which is, or can be used to derive video game content.

The machine learning models 142 on each machine learning model branch may be different. The models on at least some of the branches may be of fundamentally different types from those on some of the other branches, e.g. the machine learning models on some branches may be neural network models, while the machine learning models on other branches may be Gaussian process models, decision trees, Bayesian networks, and/or reinforcement learning models. Alternatively or additionally, where the machine learning models on at least some of the branches are neural network models, the neural network models may be of or include different neural network model types, e.g. some of the neural network models may be recursive neural networks (e.g. LSTMs or GRUs), feed-forward networks, generative adversarial networks, variational autoencoders, convolutional neural networks and/or deep reinforcement learning networks. Alternatively or additionally, where at least some of the branches are neural networks models of the same or a similar type, the neural network models may have differing structures and/or have other variations, e.g. the neural network models may have different total number of layers, different numbers of a given type of layer, different layer sizes, different layer widths, include one or more different layer types, and/or use one or more different activation functions for at least some of the layers. Alternatively or additionally, the machine learning models on at least some of the branches may have different hyperparameter values than those on other branches. Alternatively or additionally, the machine learning models on some branches may be initialized with different initial parameters than those on other branches. Alternatively or additionally, the machine learning models on at least two of the branches may be trained differently than those on another branch.

The corresponding machine learning model trainer 144 for each branch is used to train the respective machine learning model 142. Each of the machine learning model trainers 144 successively updates the respective machine learning model 142, where each update involves adjusting parameters of the model to optimise an objective function based on a set of training data for the update.

The set of training data for the update may include training pairs, where each training pair includes a training input and a ground-truth output. For each of the training pairs, a training output may be generated using the training input, and the training output may be compared to the ground-truth output to determine a measure of the difference between the training output and the ground-truth output. Based on at least a subset of these measures, an objective function value may be calculated, and the parameters of the objective function may be adjusted to optimise this value. Where the objective function is a loss function, the parameters are adjusted to reduce the loss function value. Where the objective function is a utility function, the parameters are adjusted to increase the utility function value. To appropriately adjust the parameters of the model to optimise the objective function, the machine learning model trainer 144 uses an appropriate method to determine the adjustments. For example, where the machine learning model 142 is a neural network, backpropagation may be used to determine the adjustments to the parameters, e.g. the weights of the neural network.

Examples of objective functions include, but are not limited, to mean squared error, cross-entropy loss, mean absolute error, Huber loss, Hinge loss, and Kullback-Leibler divergence. The objective function may further include one or more regularization terms, e.g. an L1 and/or an L2 regularization component, to reduce the probability of overfitting of the respective machine learning model to the training data.

Each of the machine learning model trainers 144 may use the same objective function or at least some of the machine learning model trainers 144 may use different objective functions from others of the machine learning model trainers 144. Where the objective functions are for different machine learning models 142, the objective function may be adapted to the properties of the respective machine learning model. Where the machine learning models 142 for one or more branches are the same, with the exception of their parameters, a different objective function may also be chosen such that, despite not otherwise differing, the machine learning models are trained differently so perform differently at different stages of training. For example, the differing objective functions may result in one of these ‘same’ machine learning models performing better and being more favourably evaluated at an early stage of training, while the other may perform better and be more favourably evaluated with further training.

### Development and Selection of Machine Learning Model Branches

Referring to FIG. 2, a schematic block diagram illustrating the development and selection of machine learning model branches in a computer system configured to provide video game content is shown.

The diagram illustrates the content provision server 130 receiving a plurality of requests for video game content then routing these requests to a current machine learning model 142-k^{t} of a machine learning model branch hosted on the model forest server 140.

Within the illustration of the model forest server 140, both current and former machine learning models are illustrated for several of the machine learning model branches. The machine learning models 142-a¹-142-aⁿ⁻¹, 142-b¹-142-b^{m-1}, 142-k^{t}-142-k^{t-1}, represented using dashed rounded rectangles, are the former machine learning models for each of the shown machine learning model branches. The machine learning models 142-aⁿ, 142-b^{m}, 142-k^{t}, represented using undashed rounded rectangles, are the current machine learning models for each of the shown machine learning model branches.

The machine learning model having the bold outline in each row is the machine learning model that was selected at that point in the development of the model forest, e.g. the most favourably evaluated machine learning model at that point in the development of the model forest. The model forest server initially hosted a single machine learning model branch 142-a, hence, that branch of the machine learning model forest was selected by default. Later, a second machine learning model branch 142-b was introduced, and the initial machine learning model 142-b¹ on that branch and the most recently updated machine learning model 142-a^{n-m} on the first machine learning model branch were evaluated. The initial machine learning model 142-b¹ on the second machine learning model branch 142-b was more favourably evaluated and, consequently, the second machine learning model branch of the machine learning model forest was selected. Subsequently, several new machine learning model branches are added, the last of which is machine learning model branch 142-k. The initial machine learning model 142-k^{t} on this machine learning model branch 142-k and the most recently updated machine learning models 142-aⁿ⁻¹, 142-b^{m-t} of the other branches were evaluated. At this juncture, the initial machine learning model 142-k^{t} of machine learning model branch 142-k was not the most favourably evaluated, and instead the most recently updated machine learning model 142-b^{m-t} of the machine learning model branch 142-b was the most favourably evaluated. Hence, the machine learning model branch 142-b was selected. The machine learning models on each branch were then further updated until the preceding machine learning models 142-aⁿ⁻¹, 142-b^{m-1}, . . . , 142-k^{t-1} were reached. At this juncture, the machine learning model 142-aⁿ⁻¹ was the most favourably evaluated so the machine learning model branch 142-a was selected. The machine learning models for each branch were then further updated to reach the current machine learning models 142-aⁿ, 142-b^{m}, . . . , 142-k^{t}. The most favourably evaluated machine learning model of the current machine learning models is machine learning model 142-k^{t} so the machine learning branch 142-k is selected. Hence, the requests for video game content are routed to the current machine learning model 142-k^{t} on this branch.

### Video Game Content Provision Method

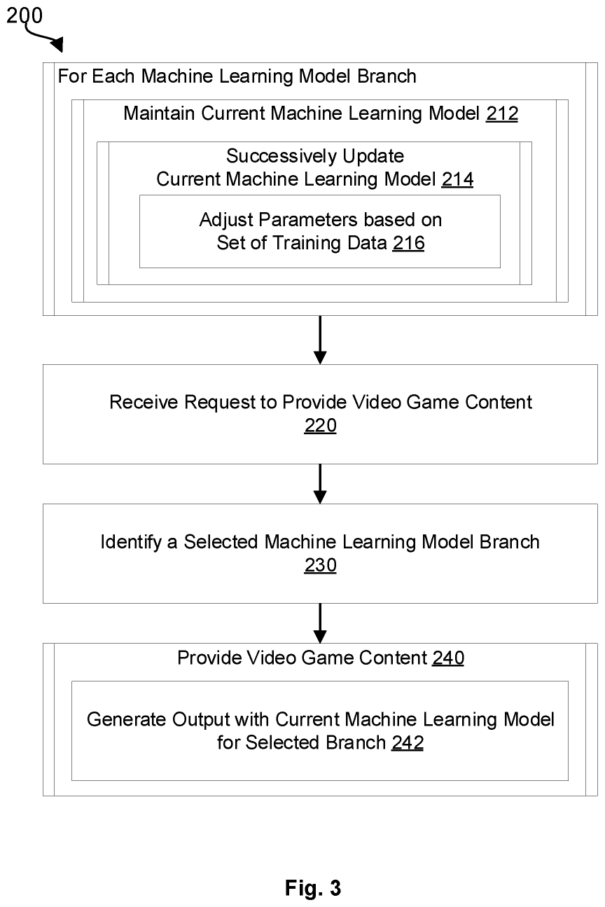

FIG. 3 is a flow diagram of an example method 200 for providing video game content. The method may be performed by executing computer-readable instructions using one or more processors of one or more computing devices, e.g. one or more computing devices of the video game content provision system 100.

In step 212, for each machine learning model branch of a plurality of machine learning model branches, a current machine learning model is maintained. The machine learning models on each machine learning model branch may be different. The models on at least some of the branches may be of fundamentally different types from those on some of the other branches, e.g. the machine learning models on some branches may be neural network models, while the machine learning models on other branches may be Gaussian process models, decision trees, Bayesian networks, and/or reinforcement learning models. Alternatively or additionally, where the machine learning models on at least some of the branches are neural network models, the neural network models may be of or include different neural network model types, e.g. some of the neural network models may be recursive neural networks (e.g. LSTMs or GRUs), feed-forward networks, generative adversarial networks, variational autoencoders, convolutional neural networks and/or deep reinforcement learning networks. Alternatively or additionally, where at least some of the branches are neural networks models of the same or a similar type, the neural network models may have differing structures and/or have other variations, e.g. the neural network models may have different total number of layers, different numbers of a given type of layer, different layer sizes, different layer widths, include one or more different layer types, and/or use one or more different activation functions for at least some of the layers. Alternatively or additionally, the machine learning models on at least some of the branches may have different hyperparameter values than those on other branches. Alternatively or additionally, the machine learning models on some branches may be initialized with different initial parameters than those on other branches.

Maintaining the current machine learning model includes the step 214 of successively updating, e.g. progressively training, the current machine learning model.

Each successive update includes the step 216 of adjusting parameters of the current machine learning model to optimise an objective function based on a set of training data for the update.

The set of training data for the update may include training pairs, where each training pair includes a training input and a ground-truth output. For each of the training pairs, a training output may be generated using the training input, and the training output may be compared to the ground-truth output to determine a measure of the difference between the training output and the ground-truth output. Based on at least a subset of these measures, an objective function value may be calculated, and the parameters of the objective function may be adjusted to optimise this value. Where the objective function is a loss function, the parameters are adjusted to reduce the loss function value. Where the objective function is a utility function, the parameters are adjusted to increase the utility function value. An appropriate method is used to determine the adjustments. For example, where the current machine learning model is a neural network, backpropagation may be used to determine the adjustments to the parameters, e.g. the weights of the neural network.

Examples of objective functions include, but are not limited, to mean squared error, cross-entropy loss, mean absolute error, Huber loss, Hinge loss, and Kullback-Leibler divergence. The objective function may further include one or more regularization terms, e.g. an L1 and/or an L2 regularization component, to reduce the probability of overfitting of the respective machine learning model to the training data.

The same objective function may be used to adjust the parameters for each of the machine learning model branches, or different objective functions may be used for different machine learning model branches. Where the objective functions are for different machine learning model branches, the objective function may be adapted to the properties of the respective current machine learning model on that machine learning model branch. Where the current machine learning models for one or more of the machine learning model branches are the same, with the exception of their parameters, a different objective function may also be chosen such that, despite not otherwise differing, the machine learning models are trained differently so perform differently at different stages of training. For example, the differing objective functions may result in one of these ‘same’ machine learning models performing better and being more favourably evaluated at an early stage of training, while the other may perform better and be more favourably evaluated with further training.

In step 220, a request to provide video game content response to specified input is received. The request may be received from a client application, e.g. game creation software, content creation software or a video game. The request may be received using any suitable mechanism, e.g. a REST call or a SOAP call; or a message queue. The request may identify the type of video game content to be provided. The type of video game content identified could be, but is not limited to, the types of video game content described above, e.g. speech audio, music, non-player character behaviour, character animations, video game terrain, locations for entities in a video game environment.

The specified input may be included in the request, and/or the specified input, or a part thereof, may have been received earlier or may be retrieved from a storage device or over a network. The specified input may include properties usable for providing the type of desired video game content. For example, the specified input may include desired traits of the video game content, e.g. for speech audio, whether the speech audio should sound happy, sad, angry, or inquisitive; and/or properties of a video game character from which the speech audio is to originate. Alternatively or additionally, the specified input may include other data which the provided video game content is to depend on. For example, where the request is received from a video game, it may be desired that the video game content, e.g. music, depends on the current game state, e.g. the health of an in-game character, the location of the in-game character, and the number of enemies in the in-game character's immediate vicinity.

In step 230, a selected machine learning model branch is identified. The selected machine learning model may have been identified based on an indication of the selected machine learning model branch received using any suitable mechanism. Examples of suitable mechanisms by which this indicator may be received include an application programming interface call; a service call, e.g. a representational state transfer (REST) call or a Simple Object Access Protocol (SOAP) call; a message queue; or shared memory. The method by which the machine learning model branch is selected is described with respect to FIG. 3.

In step 240, video game content is provided responsive to the request. The video game content may be provided to a client application, e.g. the client application from which the request originates. The type of video game content provided could be, but is not limited to, the types of video game content described above, e.g. speech audio, music, non-player character behaviour, character animations, video game terrain, locations for entities in a video game environment.

The step 240 includes a step 242 of generating an output responsive to the specified input with the current machine learning model for the selected branch. To generate the output, one or more inputs may have to be made to the current machine learning model for the selected branch. If the specified input is itself processable by the current machine learning model for the selected branch, the specified input may itself be input to this machine learning model. However, in some case, the specified input may not itself be processable by this machine learning model. In this case, the specified input is processed in order to derive one or more inputs based on the specified input that can be processed by this machine learning model, and these derived one or more inputs are inputted to this machine learning model. For example, when speech audio is requested, the type of input processable by the current machine learning model for the selected machine learning model branch may be a series of character embeddings, and the text in the specified input may be converted into suitable character embeddings. The type of input processable by the current machine learning model for each of the machine learning model branches may be the same, or the type of input processable by the current machine learning models on the different machine learning model branches may vary. Where the types of input processable by the current machine learning models on the different machine learning model branches varies, appropriate inputs may be derived from the specified input depending on which of the machine learning model branches has been selected.

The appropriate input may then be processed by the current machine learning model for the selected branch to generate an output. The generated output may itself be the video game output to be provided, or may be an output from which video game can be derived. Therefore, the step 240 of providing the video game content may further include deriving the video game content from the generated output. For example, in the case where the video game content is speech audio, and the generated output may be a series of spectrograms. The series of spectrograms may be converted into speech audio by transforming each of them from the frequency domain to the time domain to derive audio snippets, concatenating the audio snippets, and encoding the resulting audio data in an appropriate file format. As another example, in the case of terrain generation, the generated output may be a terrain heightfield and the video game content derived from it may be a 3D mesh for the terrain.

### Machine Learning Model Branch Selection Method

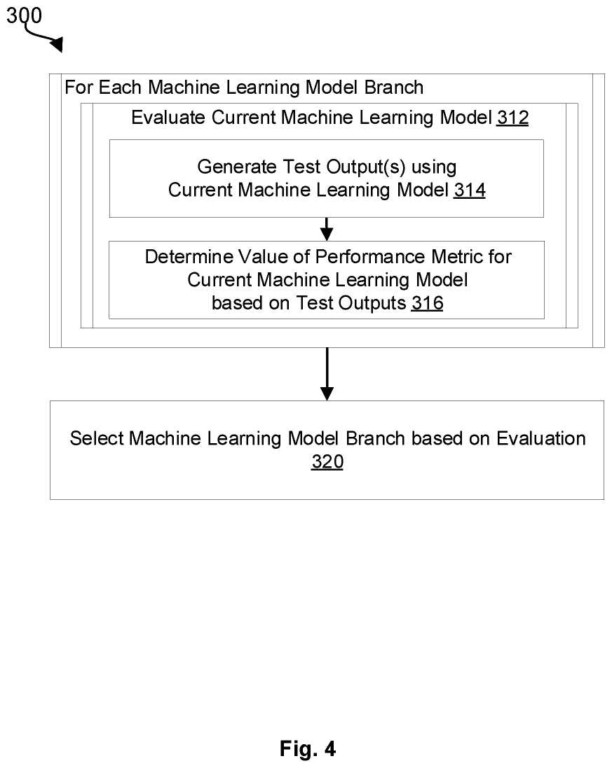

FIG. 4 is a flow diagram of an example method 300 for selecting a machine learning model branch. The method may be performed by executing computer-readable instructions using one or more processors of one or more computing devices of the video game content provision system 100.

In step 312, for each machine learning model branch of a plurality of machine learning model branches, the respective current machine learning model is evaluated.

Evaluating the current machine learning model includes a step 314 of generating test outputs using the current machine learning model. These generated test outputs may be video game content or outputs from which video game content may be derived, e.g. phonemes and/or spectrogram frames for speech audio, a terrain heightfield for use in generating a 3D mesh for an in-game terrain, or latent embeddings of the video game content. There may be a pair of a test input and a ground-truth output, of the same type as the test output, associated with each of the test outputs. These pairs of a test input and a ground-truth output may be referred to as test pairs and may be collectively referred to as the test set. The test outputs may be generated by inputting the test input of each of the test pairs to the current machine learning model.

Evaluating the current machine learning model branches further includes a step 316 of determining a value of a performance metric for the current machine learning model based on the test outputs. The performance metric value may directly or indirectly measure the quality of the video game content which can be provided using these outputs. Where test pairs including a test input and a ground-truth output have been used to generate the test outputs, calculating the performance metric may include calculating a measure of the difference between the respective test output and the ground-truth output. The measure may be a loss function, or a component thereof, used for training the current machine learning model. However, it may also be a non-loss function measure, e.g. a non-differentiable measure. The performance metric may be a summary of these values across the test set, and the performance metric may be non-differentiable. For example, the performance metric may be a sum or average of the measures for each test pair.

In step 320, the machine learning model branch is selected based on the evaluation. For example, the selected machine learning model may be the machine learning model for which the performance metric value is highest. However, other factors, in addition to the performance metric values, may be taken into account when making. For example, the selection may be based on both the performance metric value and the latency, e.g. the time it takes the machine learning model to generate an output, for each model. This selection could be made by deriving a combined metric for each current machine learning model including components for the performance metric value and the latency, and selecting the current machine learning model having the highest value for the combined metric. An example of such a combined metric is a weighted sum of the performance metric value and the latency, e.g. αp+βl, where p is the performance metric value, l is the latency, and α and β are weights.

In the above description, numerous details are set forth. It will be apparent, however, to one of ordinary skill in the art having the benefit of this disclosure that embodiments of the disclosure may be practiced without these specific details. In some instances, well-known structures and devices are shown in block diagram form, rather than in detail, in order to avoid obscuring the description.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here and generally, conceived to be a self-consistent sequence of steps leading to a desired result. The steps are those requiring physical manipulation of physical quantities. Usually, though not necessarily, these quantities take the form of electrical or magnetic signals capable of being stored, transferred, combined, compared and otherwise manipulated. It has been proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “receiving,” “identifying,” “classifying,” reclassifying,” “determining,” “adding,” “analyzing,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Embodiments of the disclosure also relate to an apparatus for performing the operations herein. This apparatus may be specially constructed for the required purpose, or it may comprise a general purpose computer selectively activated or reconfigured by a computer program stored in the computer. Such a computer program may be stored in a non-transitory computer readable storage medium, such as, but not limited to, any type of disk including floppy disks, optical disks, CD-ROMS and magnetic-optical disks, read-only memories (ROMs), random access memories (RAMs), EPROMs, magnetic or optical cards, flash memory, or any type of media suitable for storing electronics instructions.

The words “example” or “exemplary” are used herein to mean serving as an example, instance, or illustration. Any aspect or design described herein as “example” or “exemplary” is not necessarily to be construed as preferred or advantageous over other aspects of designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” in intended to mean any of the natural inclusive permutations. That is, if X includes A; X includes B; or X includes both A and B, then “X includes A and B” is satisfied under any of the foregoing instances. In addition, the articles “a” and “an” as used in this specification and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such. Furthermore, the terms “first,” “second,” “third,” “fourth,” etc. as used herein are meant as labels to distinguish among different elements and may not necessarily have an ordinary meaning according to their numerical have an ordinal meaning according to their numerical designation.

The algorithms and displays presented herein presented herein are inherently related to any particular computer or other apparatus. Various general purpose systems may be used with programs in accordance with the teachings herein, or it may prove convenient to construct a more specialized apparatus to perform required method steps. The required structure for a variety of these systems will appear from the description. In addition, the present disclosure is not described with reference to any particular programming language. It will be appreciated that a variety of programming languages may be used to implement the teachings of the disclosure as described herein.

The above description sets forth numerous specific details such as examples of specific systems, components, methods and so forth, in order to provide a good understanding of several embodiments of the present disclosure. It will be apparent to one skilled in the art, however, that at least some embodiments of the present disclosure may be practiced without these specific details. In other instances, well-known components or method are not described in detail or are presented in simple block diagram format in order to avoid unnecessarily obscuring the present disclosure. Particular implementations may vary from these example details and still be contemplated to be within the scope of the present disclosure.

It is to be understood that the above description is intended to be illustrative and not restrictive. Many other embodiments will be apparent to those of skill in the art upon reading and understanding the above description. The scope of the disclosure should, therefore, be determined with reference to the appended claims, along with the full scope of equivalents to which such claims are entitled.

1. A computer-implemented method of providing video game content using a dynamically selected machine learning model, comprising:
maintaining a current machine learning model for each of a plurality of machine learning model branches, wherein for each branch, the current machine learning model is successively updated, each update comprising adjusting parameters of the model to optimise an objective function based on a set of training data for the update;
receiving a request to provide video game content responsive to specified input;
in response to receiving the request, identifying a selected one of the machine learning model branches, wherein the machine learning model branch is selected based on an evaluation of the current machine learning model for each branch, the evaluation comprising:
generating one or more test outputs using the current machine learning model for each branch; and
determining, based on the one or more test outputs, a value of a performance metric for the current machine learning model for each branch, and
providing video game content responsive to the request, wherein providing the video game content comprises generating an output responsive to the specified input with the current machine learning model for the selected branch.

2. The method of claim 1, comprising successively changing the selected machine learning branch to determine a current optimal machine learning branch based on an evaluation of the current machine learning model for each branch, wherein identifying a selected one of the machine learning branches comprises identifying the current optimal machine learning branch.

3. The method of claim 1, wherein the current machine learning model for at least one of the plurality of machine learning model branches is of a first machine learning model type, and the current machine learning model for at least one other of the plurality of machine learning model branches is of a second, different machine learning model type.

4. The method of claim 1, wherein the current machine learning model for at least one of the plurality of machine learning model branches has first hyperparameter values, and the current machine learning model for at least one other of the plurality of machine learning model branches has different, second hyperparameter values.

5. The method of claim 1, wherein the current machine learning model for at least one of the plurality of machine learning model branches comprises a first deep generative machine learning model, and the current machine learning model for at least one other of the plurality of machine learning model branches is a different, second deep generative model.

6. The method of claim 1, wherein the current machine learning model for at least one of the plurality of machine learning model branches comprises a generative adversarial network, and the current machine learning model for at least one other of the plurality of machine learning model branches comprises a variational autoencoder.

7. The method of claim 1, wherein the objective function is different for at least one of the machine learning model branches from the objective function for at least one other of the plurality of machine learning model branches.

8. The method of claim 1, wherein the performance metric is non-differentiable.

9. The method of claim 1, wherein the selection of the machine learning model branch is further based on a latency of the current machine learning model for each machine learning model branch.

10. The method of claim 1, wherein the request to provide video game content is received from a client application and the video game content is provided to the client application.

11. The method of claim 10, wherein the client application is game creation software.

12. The method of claim 10, wherein the client application is a game engine integrated development environment.

13. The method of claim 10, wherein the client application is a video game.

14. The method of claim 1, wherein the provided video game content comprises speech audio.

15. The method of claim 1, wherein the provided video game content comprises a representation of video game terrain.

16. A distributed computing system for providing video game content using a dynamically selected machine learning model comprising a plurality of servers, wherein the distributed computing system is configured to:
maintain a current machine learning model for each of a plurality of machine learning model branches, by successively updating the current machine learning model for each branch, each update comprising adjusting parameters of the model to optimise an objective function based on a set of training data for the update;
receive a request to provide video game content responsive to specified input;
in response to receiving the request, identify a selected one of the machine learning model branches, wherein the machine learning model branch is selected based on an evaluation of the current machine learning model for each branch; and
provide video game content responsive to the request, wherein providing the video game content comprises requesting, from at least one of the one or more machine learning model forest servers, the generation of an output responsive to the specified input with the current machine learning model for the selected branch.

17. The distributed computing system of claim 16, wherein at least one of the plurality of servers is a virtual server.

18. The distributed computing system of claim 16, further comprising one or more client devices configured to:
send, to at least one of the plurality of servers, the request to provide video game content; and
receive, from at least one of the plurality of servers, the video game content responsive to the request.

19. The distributed computing system of claim 18, wherein at least one of the one or more computing devices is a video games console.

20. One or more non-transitory computer readable storage media storing computer program code that, when executed by one or more processing devices, cause the one or processing devices to perform operations comprising:
maintaining a current machine learning model for each of a plurality of machine learning model branches, wherein for each branch, the current machine learning model is successively updated, each update comprising adjusting parameters of the model to optimise an objective function based on a set of training data for the update;
receiving a request to provide video game content responsive to specified input;
in response to receiving the request, identifying a selected one of the machine learning model branches, wherein the machine learning model branch is selected based on an evaluation of the current machine learning model for each branch, the evaluation comprising:
generating one or more test outputs using the current machine learning model for each branch; and
determining, based on the one or more test outputs, a value of a performance metric for the current machine learning model for each branch, and providing video game content responsive to the request, wherein providing the video game content comprises generating an output responsive to the specified input with the current machine learning model for the selected branch.
